(19) United States
(12) Patent Application Publication
(10) Pub. No.: US 2011/0064096 A1
(43) Pub. Date: Mar. 17, 2011

(54) Mid-IR laser employing Tm fiber laser and optical parametric oscillator

(75) Inventors: Lawrence Shah, Chuluota, FL (US); Martin C. Richardson, Geneva, FL (US)

(73) Assignee: UNIVERSITY OF CENTRAL FLORIDA RESEARCH FOUNDATION, INC.

(21) Appl. No.: 12/586,011

(22) Filed: Sep. 16, 2009

(51) Int. Cl. H01S 3/30

(52) U.S. Cl. 372/6

(57) ABSTRACT

A laser system that generates light in the mid-infrared (mid-IR) wavelength range is disclosed. The laser system includes an optical fiber laser having a thulium-doped optical fiber gain medium and that is configured to generate pump light having an optical power of greater than 50 W. The laser system also includes an optical parametric oscillator (OPO) arranged to receive the pump light and configured to generate therefrom, via spontaneous parametric downconversion, mid-IR-wavelength output light. A phase-matching tuning curve is used to select the pump wavelength that provides desired signal and idler wavelengths for the outputted signal and idler light. The laser system is capable of generating high-mode-quality 100 ns optical pulses with about 400 μJ energy at an average power greater than 5 W, in some cases up to several tens of Watts, and in some cases greater than 50 W at the pump wavelength.

### FIELD OF THE INVENTION

The present invention relates generally to optical fiber lasers (“fiber lasers”); and particularly to mid-infrared (mid-IR) fiber lasers used in combination with optical parametric oscillators (OPOs).

### BACKGROUND ART

Lasers that generate light at mid-IR wavelengths have uses for a wide variety of industrial, commercial and military applications such as spectroscopic analysis, biomedical applications (e.g., “laser scalpels”), and IR countermeasures. For many if not most applications, it is preferred that the mid-IR laser be compact and lightweight and generate a high average power and spectral brightness at a relatively high repetition rate without consuming undue amounts of electrical power. It is also preferable that the output wavelength be tunable in the mid-IR, e.g., over the range from about 3000 nm to about 10,000 nm.

Conventional mid-IR lasers such as quantum cascade lasers (QCLs) have relatively low power levels (e.g., <100 mW) and virtually fixed output wavelengths. Other types of conventional lasers, such as gas lasers (e.g., frequency doubled CO₂ lasers), semiconductor lasers and chemical lasers can provide mid-IR output but have similar shortcomings, whether it be inefficiency, complexity or limited output wavelength tunability.

U.S. Patent Application Publication No. 2005/0286603, which is incorporated by reference herein, describes a thulium- (Tm-) based pump laser to drive a ZGP (i.e., ZnGeP₂) optical parametric oscillator (OPO) to generate mid-IR laser light. The Tm-based pump laser uses a Tm-doped crystal such as a YAlO₃ laser rod. However, this crystal-based laser has a number of shortcomings, including limited average power (e.g., no more than about 10 W, depending on the particular crystal used), a relatively limited repetition rate, and thermal lensing.

### SUMMARY OF THE INVENTION

One aspect of the invention is a laser system that generates light in the mid-IR wavelength range. The laser system includes an optical fiber laser comprising a Tm-doped optical fiber gain medium and configured to generate pump light of at least one wavelength. The laser system also includes an OPO arranged to receive the pump light and configured to generate therefrom, via spontaneous parametric downconversion (SPDC), mid-IR wavelength output light having an average output power of greater than 5 W.

Another aspect of the invention is a laser system for generating light in the mid-IR wavelength range from about 3,000 nm to about 10,000 nm. The laser system includes a Q-switched, Tm optical fiber laser configured to generate pump light having at least one pump-light wavelength in a tunable range from about 1950 nm to about 2100 nm. The laser system also includes an OPO arranged to receive the pump light and that comprises input and output couplers with an OP-GaAs crystal disposed therebetween so as to generate, via SPDC, idler light and signal light from the received pump light.

A further aspect of the invention is a method of generating mid-IR light in a wavelength range from about 3,000 nm to about 10,000 nm. The method includes generating pump light of at least one pump light wavelength from an optical fiber laser having a section of Tm-doped optical fiber that serves as the gain medium. The method also includes providing the pump light to an OPO configured to generate, via SPDC, mid-IR wavelength output light having an average output power of greater than 5 W.

Additional features and advantages of the invention will be set forth in the detailed description that follows, and in part will be readily apparent to those skilled in the art from that description or recognized by practicing the invention as described herein, including the detailed description that follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a schematic diagram of a generalized embodiment of the mid-IR laser system according to the present invention;

FIG. 2 is a close-up view of the pump lasers and Tm-doped fiber section for the Tm fiber laser, illustrating an example embodiment where pump light from the pump lasers is free-space coupled to the Tm-doped fiber section; and

FIG. 3 is a schematic “phase-matching tuning curve” plot of the signal and idler wavelengths λ_{S} and λ_{I} (nm) as a function of the pump wavelength λ₂₀ (nm) for an orientation-patterned gallium arsenide (OP-GaAs) crystal having a period of 61.2 μm.

### DETAILED DESCRIPTION OF THE PREFERRED EMBODIMENTS

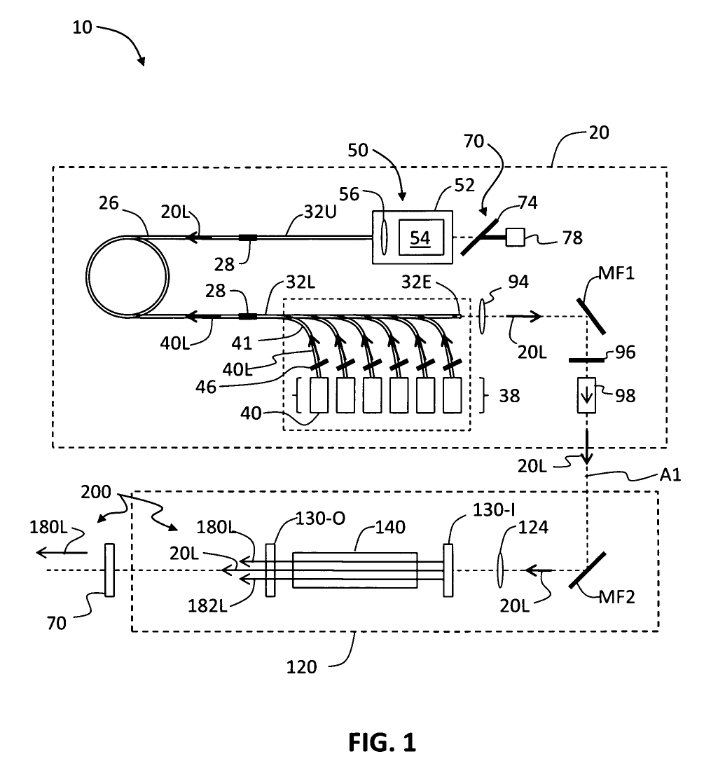

FIG. 1 is a schematic diagram of an example embodiment of a mid-IR laser system (“laser”) 10 according to the present invention. Laser system 10 has associated therewith an optical axis A1. Laser 10 includes a Tm fiber laser 20 that generates laser light 20L, and an optical parametric oscillator (OPO) 120, both of which arranged along optical axis A1. In various example embodiments, optical axis A1 is folded and is curved to correspond to the optical path of laser light 20L through Tm fiber laser 20 and OPO 120.

Tm fiber laser 20 includes a Tm-doped “active” optical fiber section 26 doped with Tm⁺³ ions and that serves as the gain medium for the Tm fiber laser. In an example embodiment, Tm-doped fiber section 26 includes a silica fiber having a 25-μm core diameter. In one example embodiment, Tm-doped fiber section 26 is optically connected (e.g., spliced via splices 28) to upper and lower undoped optical fiber sections 32U and 32L. Tm fiber laser 20 further includes a set 38 of one or more pump lasers 40 having a pump wavelength λ₄₀ and that are optically connected by respective one or more pump combiners (e.g., splices, 1×2 couplers, etc.) to one of optical fiber sections 32U or 32L. Pump lasers 40 are shown in FIG. 1 as pigtailed to respective fiber sections 41. In an example embodiment, the one or more pump lasers 40 comprise 79X nm laser diodes, where “X” indicates that the pump-laser wavelength λ₄₀ can vary within the 790 nm to 800 nm range. In an example embodiment, optical filters 46 are disposed in fiber sections 41 to prevent laser light 20L from reaching pump lasers 40.

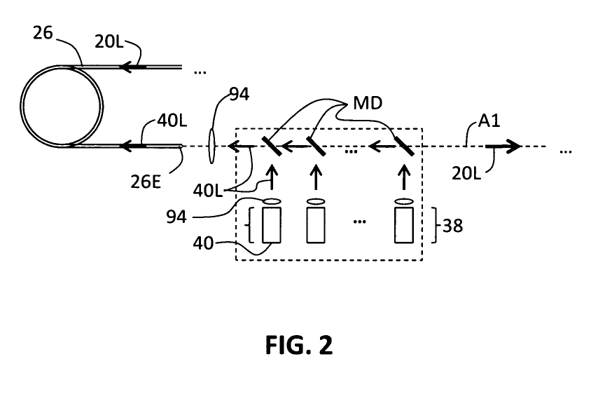

In an example embodiment, pump lasers 40 are optically coupled to Tm-doped fiber section 26 via a tapered fiber bundle. In yet another example embodiment illustrated in the close-up view of Tm fiber laser 20 of FIG. 2, pump lasers 40 are optically coupled to Tm-doped fiber section 26 through free-space using dichroic mirrors MD and focusing lenses 94 as needed. Dichroic mirrors MD are configured to reflect pump light 40L at wavelength λ₄₀ and transmit laser light 20L at wavelength λ₂₀.

With reference again to FIG. 1, Tm fiber laser 20 also includes a Q-switching device 50, such as a free-space acousto-optic modulator (AOM) unit 52 that includes, for example, an AOM 54 and a focusing lens 56. Arranged adjacent Q-switching device 50 and opposite Tm-doped fiber section 26 is a wavelength-selecting element 70, such as a reflective diffraction grating 74. In an example embodiment, wavelength-selecting element 70 is operably supported by a rotation stage 78. Wavelength-selecting element 70 is configured (and in the case of diffraction grating 74 is selectively spatially oriented) to reflect at least one select wavelength of laser light 20L back into upper fiber section 32U. In addition to using a conventional diffraction grating 74 for wavelength selection and tuning, other example wavelength-selecting elements 70 include, for example, fiber Bragg gratings (FBGs), volume Bragg gratings (VBGs), guided mode resonant filters (GMRFs), and combinations thereof.

Wavelength-selecting element 70 is used in instances where the pump phase-matching bandwidth of the non-linear crystal 140 (introduced below) in OPO 120 is small. For example, in the case of a non-linear crystal 140 in the form of an OP-GaAs crystal, the pump phase-matching bandwidth is less than 2 nm, thereby requiring a relatively narrow bandwidth Δλ₂₀ for pump light 20L generated by Tm fiber laser 20 for efficient energy conversion.

In one example embodiment, wavelength-selecting element 70 is configured to provide feedback at a single central wavelength λ₂₀ with a defined width and some range over which the central wavelength can be tuned. In another example embodiment, wavelength-selecting element 70 is configured (e.g., via a monolithic or stacked arrangement of one or more of the above-described example elements) that selects two or more separate wavelengths—say, λ_{20A}, λ_{20B}, etc. In this latter embodiment, Tm fiber laser 20 generates laser light 20L at the two or more separate wavelengths.

Lower optical fiber section 32L has an output end 32E adjacent to which is arranged a focusing lens 94 and a fold mirror MF1 arranged along optical axis A1. Also arranged along optical axis A1 on the downstream side of fold mirror MF1 is a half-wave plate 96 and an optical isolator 98, such as a Faraday isolator. As described below, laser light 20L from Tm fiber laser 20 is used as pump light for OPO 120, and so is thus referred to below as “pump light” 20L, which is not to be confused with pump light 40L from pump lasers 40.

With continuing reference to FIG. 1, OPO 120 is arranged along optical axis A1 downstream of optical isolator 98 and is optically coupled to Tm fiber laser 20. OPO 120 includes a fold mirror MF2 and a focusing lens 124 arranged along optical axis A1. In an example embodiment, focusing lens 124 has a focal length of about 150 mm. OPO 120 also includes input and output couplers 130-I and 130-O arranged along optical axis A1.

Disposed in between input and output couplers 130-I and 130-O is a non-linear crystal 140 capable of converting input (pump) light 20L from Tm fiber laser 20 into signal light and idler light 180L and 182L via SPDC. In example embodiments, non-linear crystal 140 is one of orientation-patterned gallium arsenide (OP-GaAs), zinc germanium phosphide (ZGP), silver gallium selenide (AgGaSe₂), silver gallium sulfide (AgGaS₂), silver gallium indium selenide (AGIS), cadmium silicon phosphide (CdSiP₂), and periodically poled lithium niobate (PPLN).

Input coupler 130-I is highly transmissive at the pump wavelength λ₂₀, e.g., in the range from about 1950 nm to about 2100 nm. Input coupler 130-I is also highly reflective in the mid-IR wavelength range. Output coupler 130-O is also highly transmissive at the pump wavelength λ₂₀ and is as low as ˜20% reflective in the mid-IR wavelength range.

In an example of the operation of laser 10, one or more pump lasers 40 generate pump light 40L of wavelength λ₄₀ in the range of 790 to 800 nm. Pump light 40L travels through pigtail fiber section(s) 41, through non-doped lower optical fiber section 32L and then through Tm-doped fiber section 26, thereby optically pumping the gain medium. In the alternative embodiment shown in FIG. 2, pump light 40L reflects from dichroic mirrors MD and is optically coupled into an end 26E of Tm-doped fiber section 26 via focusing lens 94.

Activation of Q-switching device 50 and the configuration of wavelength-selecting element 70 causes Tm fiber laser 20 to lase (i.e., generate laser light 20L) at a wavelength λ₂₀ of about 2,000 nm (e.g., between about 1,950 nm and 2,100 nm). Thus, in the configuration shown in FIG. 1, laser light 20L of wavelength λ₂₀ is outputted at lower optical fiber section end 32E. This light is collimated by focusing lens 94 and continues to propagate through free-space to fold mirror MF1, which directs light 20L to optical isolator 98. Optical isolator 98 serves to protect Tm fiber laser 20 from back reflections. Light 20L then travels through optical isolator 98 to OPO 120 and as mentioned above, serves as the pump light for the OPO.

In OPO 120, light 20L is focused by focusing lens 124 into the center of non-linear crystal 140. Thus, the focused light 20L passes through input coupler 130-I and enters non-linear crystal 140, where SPDC converts a substantial portion (e.g., on the order of up to 50% or even more) of this light into signal photons (“signal light”) 180L of wavelength λ_{S} and idler photons (“idler light”) 182L of wavelength λ_{I}. As discussed above, input coupler 130-I is highly transmissive at the pump light wavelength λ₂₀ from about 1,950 nm to about 2,100 nm and is highly reflective at mid-IR wavelengths. Output coupler 130-O is also highly transmissive at the pump light wavelength λ₂₀ and is as low as 50% reflective in the mid-IR wavelength range associated with the signal and idler wavelengths λ_{S} and λ_{I}. Thus, signal light 180L, idler light 182L and unconverted pump light 20L are emitted from output coupler 130-O, and constitute “output light” 200 outputted by laser 10. The selection of the particular wavelengths λ_{S} and λ_{I} for signal light 180L and idler light 182L is based on the pump light wavelength λ₂₀, as discussed in detail below.

In many instances, it is desirable to limit output light 200 to just one or two of signal light 180L, idler light 182L and unconverted pump light 20L. For example, if one wished to use pump light 20L, one can just pick off part of the pump light beam using a beamsplitter prior to this light reaching OPO 120 rather than having this light travel through the OPO, which effectively attenuates the pump light due to SPDC. Also, one may only wish to utilize a small wavelength band in the mid-IR associated with just one of signal and idler light 180L and 182L.

Thus, in an example embodiment, at least one wavelength-selecting element 70 such as one or more of a filter, a grating, etc., is arranged adjacent output coupler 130-O so as filter at least one of signal light 180L, idler light 182L and unconverted pump light 20L, thereby providing a greater degree of wavelength selection for laser 10. FIG. 1 shows by way of example a single wavelength-selecting element 70 arranged adjacent output coupler 130-O and configured to filter idler light 182L and residual pump light 20L. Two such elements 70 configured to respectively filter idler light 182L and residual pump light 20L while transmitting signal light 180L could also be used to achieve this result.

A preferred embodiment of laser 10 utilizes a non-linear crystal 140 in the form of an OP-GaAs crystal. Present-day manufacturing limitations restrict this non-linear crystal's clear aperture to <2 mm, with most OP-GaAs crystals having a thickness <500 μm. Consequently, for such non-linear crystals 140, pump light 20L is focused by focusing lens 124 to a beam waist of <200 μm (full width at 1/e² of the maximum intensity) at the center of the crystal. Prior art OPO cavities generally consist of a flat-flat mirror set that partially recycles both the signal and idler photons. For a typical OP-GaAs crystal length of 15 mm to 20 mm, the OPO 120 of the present invention has a length of about 25 mm to about 30 mm, which ensures efficient energy conversion of the pump light 20L to signal light 180L and idler light 182L. Conversion efficiencies of greater than 50% from pump light 20L to signal light 180L and idler light 182L have been achieved in laser 10.

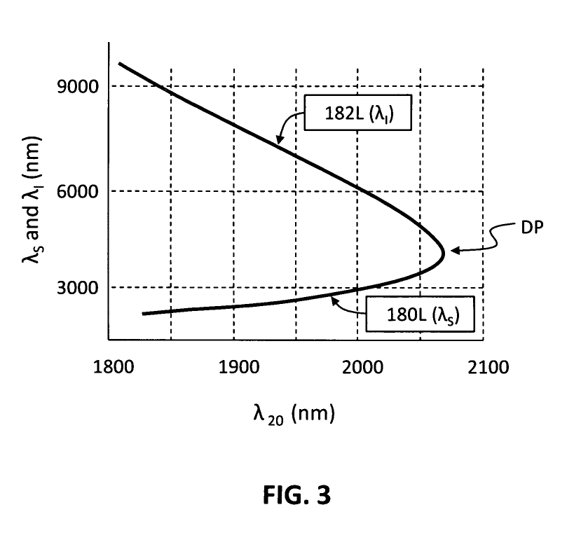

FIG. 3 is a schematic “phase-matching tuning curve” plot of the signal and idler wavelengths λ_{S} and λ_{I} (nm) as a function of the pump wavelength λ₂₀ (nm), as adapted from the article by K. L. Vodopyanov et al., entitled “Optical parametric oscillation in quasi-phase-matched GaAs,” Opt. Lett. 20, p. 1912 (2004), which article is incorporated by reference herein. FIG. 3 shows the correspondence between the pump wavelength λ₂₀ and the signal and idler wavelengths λ_{S} and λ_{I} for signal light 180L and idler light 182L generated by SPDC for an all-epitaxially-grown OP-GaAs crystal 140 that is 0.5 mm thick, 5 mm wide, and 11 mm long, with a domain reversal period of 61.2 μm. The regions of the curve associated with signal light 180L and idler light 182L are labeled on the plot, along with the degeneracy point DP where both the signal and idler light have the same wavelength.

The shape of the phase matching curve of FIG. 3 depends upon the orientation period of non-linear crystal 140. Therefore, the choice of the particular non-linear crystal 140 should be “matched” to Tm fiber laser 20. It is also common with a PPLN non-linear crystal 140 to create a waveguide with several domains near one another so that changing the position of the beam in the crystal changes the output wavelength(s) of OPO 120.

The plot of FIG. 3 shows how to select signal and idler wavelengths λ_{S} and λ_{I} by selecting the pump wavelength λ₂₀. By tuning the pump wavelength λ₂₀ from 1,950 nm to 2,100 nm, the wavelength λ_{S} of signal light 180L is made to vary from 2,750 nm to 3,500 nm while the wavelength λ_{I} of the idler light 182L is made to vary from 4,900 nm to 7,000 nm for the particular OP-GaAs crystal. For example, for a pump wavelength of λ₂₀=2,000 nm, the signal light 180L will have a wavelength λ_{S}=3,000 nm while the idler light 182L will have a wavelength λ_{I}=6,000 nm.

In an example embodiment, the phase-matching curve of FIG. 3 is also tuned by varying the temperature of the OP-GaAs crystal to shift the signal and idler wavelengths λ_{S} and λ_{I}, so that laser 10 is capable of emitting light in the mid-IR wavelength range from about 3,000 nm to about 10,000 nm. Such the temperature tuning does not typically provide a strong increase in range. However, it can be used to shift the effective phase matching such that the signal and idler shift by about ±1,000 nm from standard operating conditions.

Different non-linear crystals 140 have similar types of phase-matching tuning curves. Likewise, variations in the configuration of the particular non-linear crystal 140, such as the poling period of an OP-GaAs crystal, give rise to variations in the phase-matching tuning curve.

The selection of the output signal and idler wavelengths λ_{S} and λ_{I} depends upon the choice of the pump wavelength(s) λ₂₀ and the phase-matching condition—for example, the period of the orientation patterning in an OP-GaAs non-linear crystal 140. As such, in a preferred embodiment the bandwidth of pump light 20L is narrow (e.g., sub-nanometer), which generates correspondingly narrow linewidths for the signal light 180L and idler light 182L. Wavelength tuning of the signal and idler output wavelengths λ_{S} and λ_{I} occurs as a result of changing either the pump wavelength λ₂₀ and/or the phase-matching condition of non-linear crystal 140 so as to trace out as much of the phase-matching curve (FIG. 3) as possible.

As described above, in an example embodiment Tm fiber laser 20 is configured (via wavelength-selecting element 70) to simultaneously produce more than one wavelength λ₂₀. In this example, OPO 120 is configured to output multiple signal and idler output wavelengths λ_{S} and λ_{I} (e.g., λ_{SA}, λ_{SB}, . . . and λ_{IA}, λ_{IB}, . . . ). By way of example, it may be desirable to have one output wavelength from Tm fiber laser 20 in the range from 2,500 nm to 3,000 nm and simultaneously have output from 4,500 nm to 5,000 nm. However, as can be seen from FIG. 3, these two wavelength ranges cannot be covered simultaneously using an OPO 120 pumped by with a single wavelength λ₂₀.

On the other hand, if Tm fiber laser 20 is configured to generate output light 20L having two wavelengths—say λ_{20A} at about 1,980 nm and λ_{20B} at about 2,050 nm—the signal light 180L of the shorter wavelength pump λ_{20A} can have a signal wavelength λ_{SA} the range from 2,500 nm to 3,000 nm and the idler light 182L from the longer wavelength pump λ_{20B} can have an idler wavelength λ_{IB} in the range from 4,500 nm and 5,000 nm. Thus, a multi-wavelength Tm fiber laser 20 allows for greater tunability of the output signal and idler wavelengths λ_{S} and λ_{I}.

The reflectivities of the input and output couplers 130-I and 130-O of OPO 120 play a secondary role in controlling the signal and idler output wavelengths λ_{S} and λ_{I}. Generally, it is preferred that the reflectivities of input and output couplers 130-I and 130-O are chosen to provide as wide a mid-IR output wavelength range as possible. In an example embodiment, input and output couplers 130-I and 130-O are highly reflective from 3,000 nm to 5,000 nm. In other example embodiments, input and output couplers 130-I and 130-O are more closely optimized to only the signal wavelength λ_{S} or only the idler wavelength λ_{I}.

The use of Tm-doped fiber 26 as the gain medium provides laser 10 with a number of advantages over the prior art laser systems, including a smaller form factor, better mode quality, and higher average power. While the prior art lasers are generally limited to average output powers of just a few Watts, Tm fiber laser 20 is cable of generating pump light 20L of greater than about 50 W and up to about 100 W, which allows laser 10 to generating output light 200 in the form of 100 ns optical pulses with about 400 μJ energy at an average power of greater than 5 W, and even several tens of Watts, and in one example embodiment greater than about 50 W.

These average power values represent the power of signal light 180L or idler light 182L and ignore residual pump light 20L. Generally, signal light 180L and idler light 182L have about the same amount of power, with the idler light having slightly less power due to the higher energy per photon. For each photon of signal light 180L, there should, in principle, be one photon of idler light 182L. Variations in the number of signal and idler photons can of course vary due to attenuation along the optical path both in the OPO and beyond.

In an example embodiment, the repetition rate of system 10 is in the MHz range for average powers in excess of 250 W. In example embodiments where lower average power, <50 W, is used, the repetition rate is between about 20 KHz and about 100 kHz. A general range for the repetition rate is between 50 KHz and 1 MHz.

The photon bandwidths of signal and idler light 180L and 182L are typically similar to that of pump light 20L. Typically, the pump bandwidth Δλ₂₀<2 nm for pumping an OP-GaAs-based OPO 120, so the signal and idler bandwidths are typically <10 nm. Instabilities in Tm fiber laser 20 can lead to variations in the signal and idler bandwidths.

The various configurations of laser 10 are amenable to modular design and compact and rugged packaging. Laser 10 is thus suitable for use in a variety of applications, such as for infrared countermeasures, spectroscopic analysis, and “laser scalpel” applications relying upon specific absorption resonances of biological tissue in the mid-IR. Laser 10 could replace a wide variety of other sources currently used in such applications, such as QCLs, mid-IR FELs, and periodically poled lithium niobate- (PPLN-) based OPOs. Direct tuning of the laser wavelength λ₂₀ and/or the OPO crystal temperature enables laser 10 to produce high-power mid-IR output tunable from about 3,000 nm to about 10,000 nm with the use of appropriate OPO input and output couplers 130-I and 130-O and non-linear crystal 140.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A laser system that generates light in a mid-infrared (mid-IR) wavelength range, comprising:
an optical fiber laser comprising a thulium-doped optical fiber gain medium and configured to generate pump light having at least one wavelength; and
an optical parametric oscillator (OPO) arranged to receive the pump light and configured to generate therefrom, via spontaneous parametric downconversion, mid-IR wavelength output light having an average output power of greater than 5 Watts.

2. The laser system of claim 1, wherein the pump light from the optical fiber laser has a power in the range from about 50 W to about 100 W.

3. The laser system of claim 1, wherein the repetition rate of the output light is between about 50 KHz and 200 KHz.

4. The laser system of claim 1, wherein the optical fiber laser is tunable so as to generate the pump light of at least one pump-light wavelength between about 1,950 nm and about 2,100 nm.

5. The laser system of claim 1, wherein the OPO includes a non-linear crystal selected from the group of non-linear crystals comprising: orientation-patterned gallium arsenide (OP-GaAs), zinc germanium phosphide (ZGP), silver gallium selenide (AgGaSe₂), silver gallium sulfide (AgGaS₂), silver gallium indium selenide (AGIS), cadmium silicon phosphide (CdSiP₂), and periodically poled lithium niobate (PPLN).

6. The laser system of claim 1, wherein the output light includes signal light, idler light and pump light, and further comprising at least one wavelength-selecting element arranged adjacent an output end of the OPO so as to filter at least one of the signal light, idler light and pump light.

7. The laser system of claim 1, wherein the OPO comprises input and output couplers between which is disposed an orientation-patterned gallium arsenide (OP-GaAs) crystal.

8. The laser system of claim 7, wherein the input and output couplers are configured so that the light outputted by the OPO has a mid-IR wavelength between 3,000 nm and 10,000 nm.

9. The laser system of claim 7, wherein the pump light wavelength is selected so as to generate signal and idler light of select wavelengths from the OPO according to a phase-matching tuning curve for the OP-GaAs crystal.

10. A laser system for generating light in a mid-infrared wavelength range from about 3,000 nm to about 10,000 nm, comprising:
a Q-switched, thulium optical fiber laser configured to generate pump light having at least one pump-light wavelength in a tunable range from about 1,950 nm to about 2,100 nm; and
an optical parametric oscillator (OPO) arranged to receive the pump light and comprising input and output couplers with an orientation-patterned gallium arsenide (OP-GaAs) crystal disposed therebetween so as to generate, via spontaneous parametric downconversion, idler light and signal light from the received pump light.

11. The laser system of claim 10, wherein the OPO outputs through the output coupler the signal light, idler light and a portion of the pump light, and further comprising at least one wavelength-selecting element arranged adjacent an output end of the OPO so as to filter at least one of the signal light, idler light and pump light.

12. The laser system of claim 10, wherein the outputted signal light and idler light each have an optical power of at least 10 W.

13. The laser system of claim 10, wherein the input and output couplers are configured so that the light outputted by the OPO has a mid-IR wavelength between 3,000 nm and 10,000 nm.

14. The laser system of claim 10, wherein the pump light from the thulium optical fiber laser has optical power in the range from about 50 W to about 100 W.

15. A method of generating mid-infrared (mid-IR) light in a wavelength range from about 3,000 nm to about 10,000 nm, comprising:
generating pump light having at least one pump light wavelength from an optical fiber laser having a section of thulium-doped optical fiber that serves as a gain medium; and
providing the pump light to an optical parametric oscillator (OPO) configured to generate, via spontaneous parametric downconversion, mid-IR wavelength output light having an average output power of greater than 5 W.

16. The method of claim 15, further including operating the optical fiber laser so that the pump light has an optical power in the range from about 50 W to about 100 W.

17. The method of claim 15, further including causing the output light to have a repetition rate equal between about 100 KHz and 200 KHz.

18. The method of claim 15, including providing the OPO with a non-linear crystal selected from the group of non-linear crystals comprising: orientation-patterned gallium arsenide (OP-GaAs), zinc germanium phosphide (ZGP), silver gallium selenide (AgGaSe₂), silver gallium sulfide (AgGaS₂), silver gallium indium selenide (AGIS), cadmium silicon phosphide (CdSiP₂), and periodically poled lithium niobate (PPLN).

19. The method of claim 15, including configuring the OPO by providing input and output couplers and disposing therebetween an orientation-patterned gallium arsenide (OP-GaAs) crystal.

20. The method of claim 15, including selecting the at least one pump light wavelength so as to generate signal and idler light of select wavelengths from the OPO according to a phase-matching tuning curve for the OP-GaAs crystal.
